(19) United States
(12) Patent Application Publication
(10) Pub. No.: US 2013/0114772 A1
(43) Pub. Date: May 9, 2013

(54) Large Amplitude Vibration Mechanical Launch Apparatus

(71) Applicant: Paul Rosso, Livermore, CA (US)

(72) Inventor: Paul Rosso, Livermore, CA (US)

(73) Assignee: Lawrence Livermore National Security, LLC, Livermore, CA (US)

(21) Appl. No.: 13/625,630

(22) Filed: Sep. 24, 2012

Related U.S. Application Data
(60) Provisional application No. 61/537,794, filed on Sep. 22, 2011.

(51) Int. Cl. G21B 1/15; F41B 7/00

(52) U.S. Cl. CPC G21B 1/15; F41B 7/00
USPC 376/101; 124/16

(57) ABSTRACT

System and methods for launching a projectile are provided. The launching apparatus may include a flexible beam and drivers attached to the ends of the beam. The drivers may drive the ends of the beam to induce a steady large amplitude vibration in the beam. The induced vibration causes the beam to oscillate between two catenary-like configurations. A projectile may be loaded on the midpoint region of the beam when the midpoint region of the beam reaches a peak displacement with a near zero velocity and acceleration. The projectile may then be pushed and accelerated by the beam vibration and launched from the beam when the midpoint region reaches a peak velocity and midpoint acceleration reaches zero.

### CROSS-REFERENCES TO RELATED APPLICATIONS

This application claims the benefit of U.S. Provisional Application No. 61/537,794 filed on Sep. 22, 2011, the full disclosure of which is incorporated by reference herein in its entirety for all purposes.

### STATEMENT AS TO RIGHTS TO INVENTIONS MADE UNDER FEDERALLY SPONSORED RESEARCH AND DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND

The present invention relates generally to a method and apparatus for launching projectiles. More specifically, embodiments of the present invention relate to a method and apparatus for launching fuel targets (or “targets”) into an inertial confinement fusion (“ICF”) chamber.

Since the 1970's, scientists have experimented with powerful laser beams to compress and heat hydrogen fuel to the point of fusion in a technique called inertial confinement fusion. This technique is an approach to fusion that relies on the inertia of the fuel mass to provide containment. Research and development in this area is ongoing and aimed at developing an efficient inertial fusion energy (“IFE”) power plant. In such a plant, a small target is delivered into a fusion chamber and one or more high energy lasers impact the target at or near the center of the fusion chamber. The impact compresses and heats the hydrogen fuel of the target to initiate a fusion reaction. The fusion reaction produces heat and radiation which may then be used to drive a conventional steam turbine for electricity production. This process would then repeat at a high frequency, such as 1-20 times per second, so as to produce a continual supply of electricity.

The process of injecting targets into an inertial confinement fusion reactor is challenging because the fuel inside the target is frozen and is thus sensitive to heat exposure. A target's prolonged exposure to the high heat environment of the fusion chamber before laser impact may reduce the hydrogen fuel's ability to undergo a fusion reaction. Additionally, the target is sensitive to high jerk and high rates of acceleration. One suggested approach to minimize the fuel target's exposure to a high heat environment of a fusion chamber is to deliver the target at an extremely high velocity in order to minimize the target's time in the chamber prior to laser impact.

The inventor of the present application has developed a robust target launch mechanism that may launch targets at a high rate of speed and may provide a smooth and controlled acceleration during target launch.

### SUMMARY

Certain embodiments of the present invention generally provide a system and method which may launch projectiles (also referred to herein as “target” or “targets”) at a high frequency and velocity. In some embodiments, the apparatus and method may be used to launch targets into a fusion chamber. Further embodiments provide a smooth and controlled acceleration to provide minimal shock loading to the projectile during launch. In some embodiments, a purely mechanical approach is provided which minimizes the energy input into a fusion reactor process so as to increase a fusion reactor's overall efficiency. Some embodiments may be utilized to reduce the material requirements for launching a target. Other embodiments may minimize the amount of heat added to a fuel target during launch due to sliding friction. Some embodiments may avoid using a barrel or ramp to accelerate the target. Certain embodiments avoid adding heat associated with inductive and electromagnetic acceleration to the target.

For example, in one embodiment of the present invention, a mechanical launch apparatus is provided for use with an inertial confinement fusion reactor. The exemplary apparatus may be located above a fusion reaction chamber to launch fuel targets in a downward trajectory into the fusion chamber. The exemplary apparatus comprises a flexible beam and drivers attached to both ends of the beam. In concert, the drivers repeatedly drive both ends of the beam in a manner to induce a steady vibration in the beam between the two ends. The driving input at the ends of the beam cause the beam to oscillate between two catenary curve like configurations about an equilibrium point. The manner of input may be configured to induce the vibration efficiently, to reduce system fatigue, and may accommodate beam configuration lengths and strain limits. The midpoint region of the beam forms the vertex of the opposing catenary-like configurations and hence has the largest displacement during each vibration cycle of the beam. Once the beam's vibration frequency and amplitude stabilize, a fuel target may be loaded at the midpoint in the beam during a loading period. The target may be loaded on the beam and the beam's vibration cycle accelerates the target in a smooth and controlled manner toward the fusion chamber. When the target reaches a launch point of the beam's large amplitude vibration cycle, the target may be launched at a high velocity along a midpoint vibration trajectory towards the fusion reaction chamber. The launch point is a point in the beam's large amplitude vibration cycle where the midpoint velocity at a peak velocity in the direction of the fusion chamber. Thereafter, additional targets may be loaded, accelerated, and launched each time the midpoint region oscillates back to about its peak displacement from the chamber.

In a particular embodiment, the system may employ a beam with a carbon fiber composition which ranges between about 6-12 meters in length with a varying cross section along the beam length. The beam thickness may vary between about 0.5 centimeters to about 2 centimeters along the beam height and length. Additionally, the drivers described above may be hypocycloidal drivers although many other drivers are available which can be utilized to deliver the proper driving motions at the beam ends. Further, with such a configuration, the beam may have a vibration frequency of 8-16 Hz. Thus, in this particular embodiment, the apparatus may launch 8-16 fuel targets into a fusion reaction chamber each second. Additionally the apparatus midpoint launch velocity may range from 150-200 m/s.

This particular embodiment uses a purely mechanical approach which avoids many issues with other proposed projectile launching systems. For example, this embodiment avoids potential heating of the target during launch due to a sliding friction along a ramp/tube/barrel or due to inductive and electromagnetic acceleration. Further, this embodiment can minimize the material requirements for launching a target by avoiding gas and chemical consumption during target launch. The exemplary embodiment also avoids barrel or launch tube wear, maintenance, and repair by utilizing the inherent characteristics of the midpoint trajectory during the beam's large amplitude vibration to guide the fuel target to the fusion chamber. Additionally, by monitoring the position, velocity, and acceleration measurements of the midpoint region of the beam during the beam's large amplitude vibration, the consistency of the fuel target's acceleration profile may be controlled throughout the life of the launch device.

Although this exemplary embodiment has been described in great detail above, many variations are available. Further features of the invention, its nature and various advantages will be more apparent from the accompanying drawings and the following detailed description.

### BRIEF DESCRIPTION OF THE DRAWINGS

FIG. 1 depicts an exemplary modified system design of an inertial confinement fusion reactor;

FIG. 2 depicts a flow chart representing a method for creating a fusion reaction according to embodiments of the present invention;

FIG. 3 illustrates an embodiment of the present invention adjacent to a fusion reaction chamber;

FIG. 4 illustrates an exemplary beam which may be used with certain embodiments of the present invention;

FIGS. 5A-5F illustrate a vibration cycle of the embodiment shown in FIG. 3 where both ends of the beam receive driving input;

FIGS. 6A-6F illustrate a vibration cycle of another exemplary embodiment which receives driving input at both ends of the beam;

FIG. 7 illustrates another exemplary embodiment where driving input is received at one end of a cantilevered beam and the cantilevered end may be used to launch a projectile;

FIGS. 8A-8G illustrate a vibration cycle of another exemplary embodiment which utilizes two flexible beams;

FIGS. 9A-9F illustrate a vibration cycle of another exemplary embodiment which utilizes two beams and each beam comprises two rigid members coupled in series;

FIG. 10 illustrates an exemplary velocity and acceleration profile chart of a midpoint region during one vibration cycle of the embodiments illustrated in FIG. 5 and FIG. 8;

FIGS. 11A-11B illustrate an exemplary development of a deflected beam shape for a beam vibration launch apparatus;

FIG. 12 illustrates an exemplary beam in an exemplary maximum downward deflection;

FIG. 13 illustrates an exemplary calculated driving force which may produce an exemplary vibration signature in the embodiment in FIG. 6;

FIG. 14 illustrates an exemplary midpoint region's position, velocity, and acceleration over multiple cycles of an exemplary vibration signature according to the smoothed moment input shown in FIG. 13 for the embodiment in FIG. 6; and

FIG. 15 depicts a flow chart for a method which may be employed with certain embodiments of the present invention.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

The projectile launch apparatus may be used to launch various types of projectiles. The dimensions and materials of the apparatus may vary depending on, for example, the intended use, the velocity and acceleration required, and any velocity or acceleration constraints. Although embodiments described herein are generally directed to launching hydrogen fuel targets into a fusion chamber, it should be understood that there is no intention to limit the invention to the specific form or forms of projectiles disclosed. Accordingly, the invention described herein should be limited only by the language of the claims.

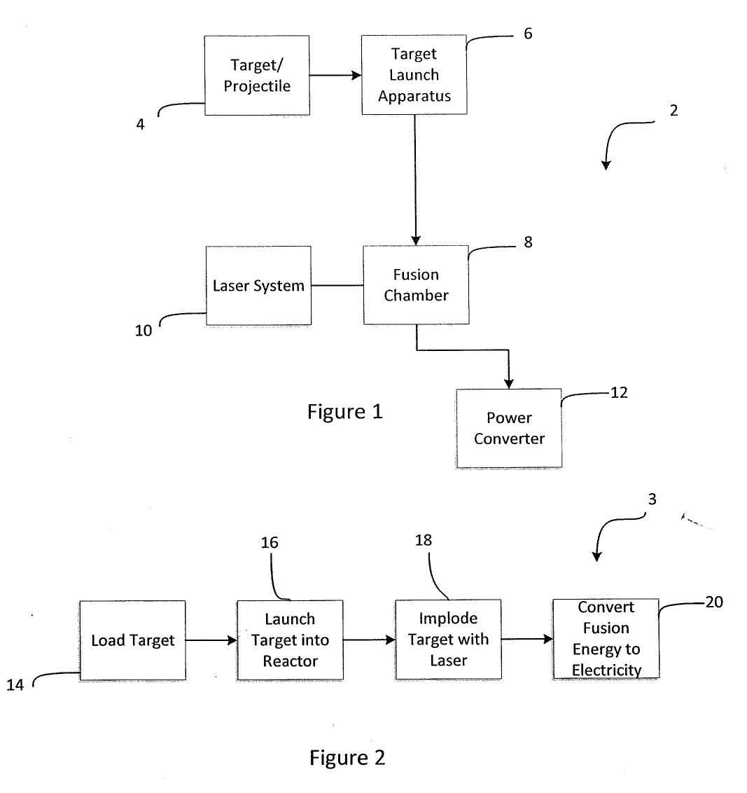

The projectile launch apparatus described herein may be used with current IFE designs and methods. As an example, an exemplary modified IFE power plant design 2 is represented in FIG. 1. Referring to FIG. 1, the IFE power plant 2 includes targets 4, exemplary target launch apparatus 6, fusion chamber 8, laser system 10, and power converter 12. Targets 4 are individually delivered to exemplary target launch apparatus 6. Exemplary target launch apparatus 6 launches or injects the individual targets 4 into fusion chamber 8 in high repetition and high velocity. Laser system 10 is coupled to fusion chamber 8 and directs high power laser energy at target 4 after it enters fusion chamber 8. The laser energy induces a fusion reaction of the hydrogen fuel in target 4. Power converter 12 converts energy generated from the fusion reaction to electricity.

FIG. 2 provides a high-level flow diagram of an exemplary modified process 3 used in fusion system 2. At 14, the target/projectile is loaded in to an exemplary launch apparatus. The exemplary launch apparatus then launches or injects the target/projectile into a fusion chamber 16. A laser system may then direct high-power laser energy at the target to induce implosion of the hydrogen fuel 18 so as to produce a fusion reaction. At 20, the energy released from the fusion reaction is converted to electricity.

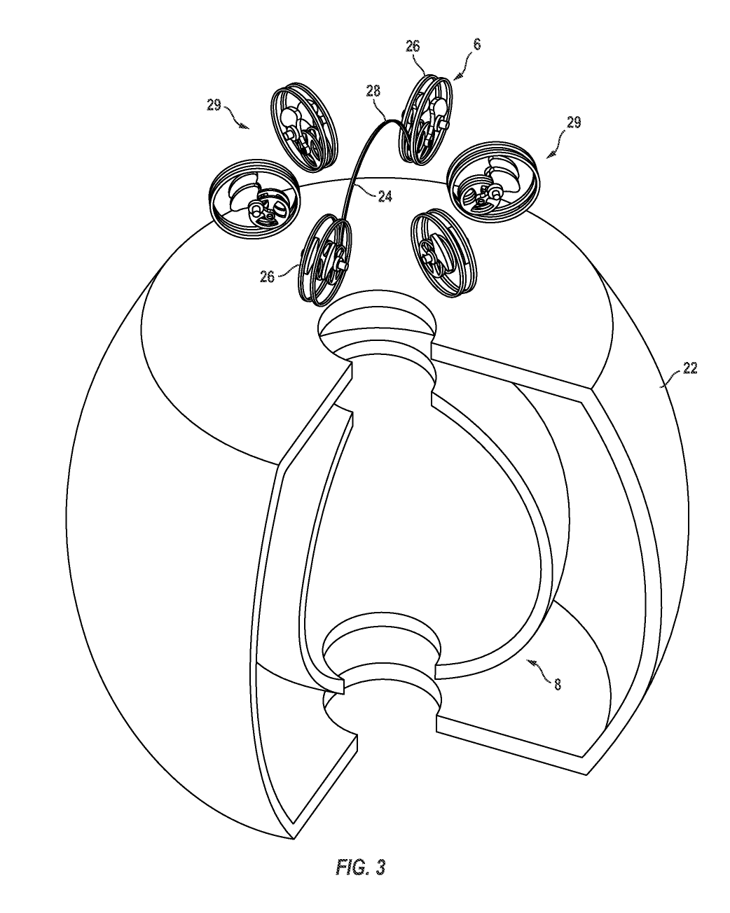

FIG. 3 depicts exemplary target launch apparatus 6 relative to fusion chamber 8 and outer shell 22. In some embodiments, exemplary launch apparatus 6 may be positioned above fusion chamber 8 and may be configured to launch target 4 in a downward trajectory through an opening in outer shell 22 and an opening in fusion chamber 8. Multiple pairs of back-up drivers 29 may be positioned at clocked positions around the openings so as to simplify the replacement or switching between various target launch apparatus 6.

Target launch apparatus 6 includes flexible beam 24 and two drivers 26 coupled to the ends of beam 24. Beam 24 further includes midpoint 28 which is located between the ends of beam 24. Drivers 26 are configured to drive both ends of beam 24 in concert so as to induce a steady and large amplitude vibration in beam 24. In some embodiments, one driver 26 may be coupled to each end of the beam. In order to ensure that the ends of beam 24 are driven in unison, the two drivers may be synchronized to achieve a smooth and stable vibration. For example, drivers 26 may be mechanically coupled or drivers 26 may be coupled to a computer processor which coordinates the driving input. In other embodiments, a single driver may be coupled to both ends of the beam in order to drive the two ends in unison. In this instance, there may be no need for synchronization since a single driver is driving both ends of the beam. This configuration may also result in fewer parts and a simpler design.

As discussed above, the input of drivers 26 cause the beam to oscillate between two opposing catenary-like configurations with midpoint region 28 forming the vertex of each catenary-like configuration. Since midpoint region 28 forms the vertex of the opposing configurations, midpoint region 28 has the largest displacement compared to any other location on beam 24 during each vibration cycle. This also means that midpoint region 28 has higher velocity and acceleration rates during the vibration cycle. Further, with this particular vibration configuration, midpoint region 28 of beam 24 oscillates between the two peak displacements along a straight line. Thus, projectiles/targets launched from midpoint region 28 of the beam travel along the same midpoint trajectory. In some embodiments, this configuration may be used to facilitate the aiming of launched projectiles/targets from apparatus 6.

The openings of outer shell 22 and fusion chamber 8 may include a shutter which opens and closes with a frequency corresponding to the target launch rate. Outer shell 22 may house inner fusion chamber 8 in a substantial vacuum in order to better manage the high heat environment of fusion chamber 8 during operation. Target launch apparatus 6 may also operate in a substantial vacuum to minimize heat exposure to target 4 and to maintain the vacuum of the outer shell 22.

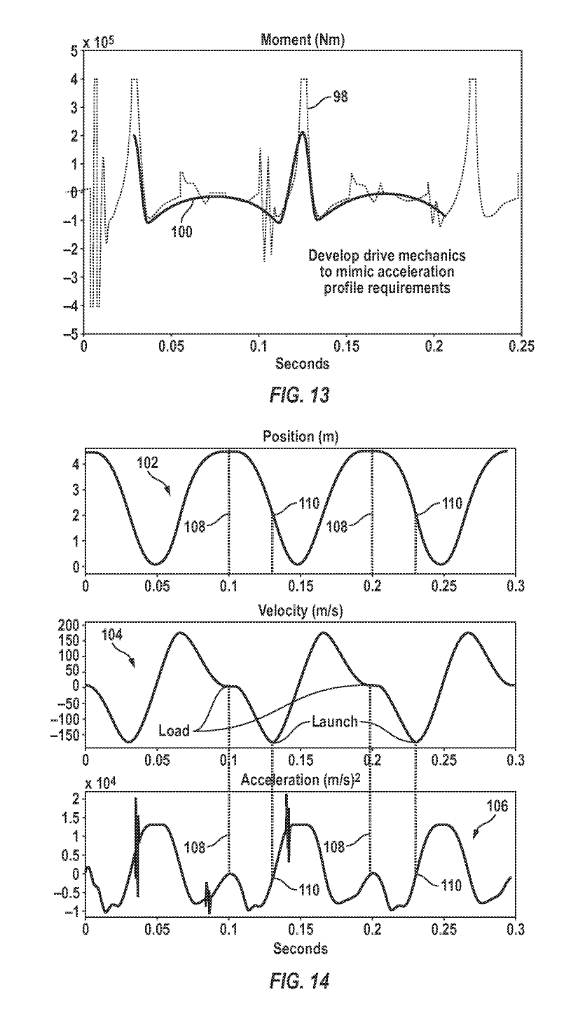

Back-up drivers 29 may be used to simplify the switching from one launch apparatus 6 configuration to another. For example, if drivers 26 malfunction or require maintenance then beam 24 may be removed and reattached to a pair of opposing back-up drivers 29. Alternatively, back-up drivers 29 may be used to test various launch apparatus 6 configurations. For example, although drivers 26 and back-up drivers 29 are all illustrated as hypocycloidal drivers, other drivers 26 may be used and tested. In addition, drivers 26 and back-up drivers 29 may each be configured to induce different vibration configurations in beam 24 for launching targets into fusion chamber 8. The steady large amplitude vibration of beam 24 induced by drivers 26 may be used to launch target 4 into fusion chamber 8 according to the method described in FIG. 13.

FIG. 4 illustrates an exemplary beam 24 configuration. In some embodiments the beam is designed according to desired vibration signatures. The vibration signatures may depend from the maximum acceleration rate that the projectile can survive and the velocity that the projectile needs to be launched at. Thus, depending on the desired use, beam 24 configuration may vary widely. For example, in some embodiments where the launch velocity is about 100 m/s to about 300 m/s and the maximum acceleration rate is between about 7000 m/s² to about 8000 m/s², the vibration frequency may be about 1 Hz to about 20 Hz. For such a vibration signature, beam 24 may be between about 4 meters to about 20 meters in length. Certain embodiments may utilize a beam between about 6 meters and about 12 meters in length. The midpoint region of the beam may vary between about 5 cm to about 25 cm wide. Certain embodiments may utilize a beam with a midpoint region between about 10 cm to about 20 cm. Further, in some embodiments beam 24 may include flared ends 90 to increase torsional rigidity at the beam ends. In some embodiments the ends may range between about 45 cm and 110 cm. Further, beam 24 may have a thickness from about 0.5 cm to about 3 cm. In some embodiments the cross section of beam 24 is non-constant along the beam length. Although ranges are provided, it should be clear that many configurations of beam 24 are possible depending on the desired acceleration rates and velocity rates.

Additionally the beam composition may depend on the intended use of a launch apparatus, the amplitude of vibration, and the deflection the beam experiences. In some embodiments, beam 24 is configured such that the desired vibration stays within the strain limits of the beam material. In certain embodiments, beam 24 may comprise a carbon fiber material with a low moment of inertia in the flexing directions. In certain embodiments beam 24 may comprise stainless steel or spring steel. Other embodiments may use other metallic materials, polymers, or epoxies for beam 24. Once the beam configuration has been chosen, the beam endpoint motions may then be calculated so as to create a desired beam vibration.

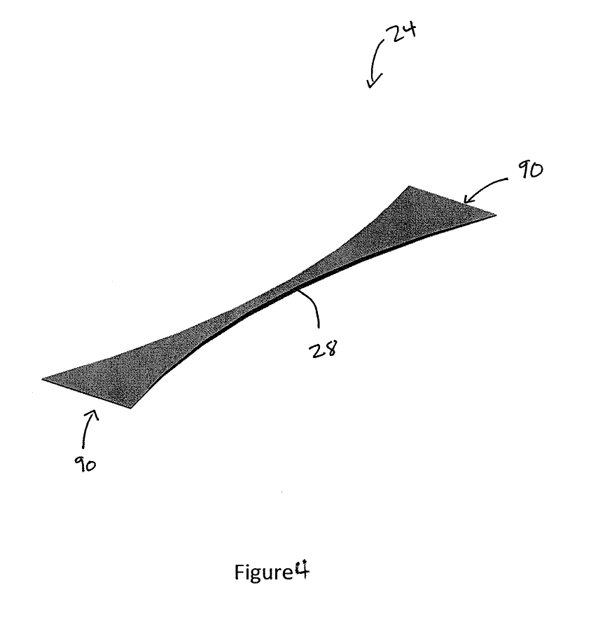

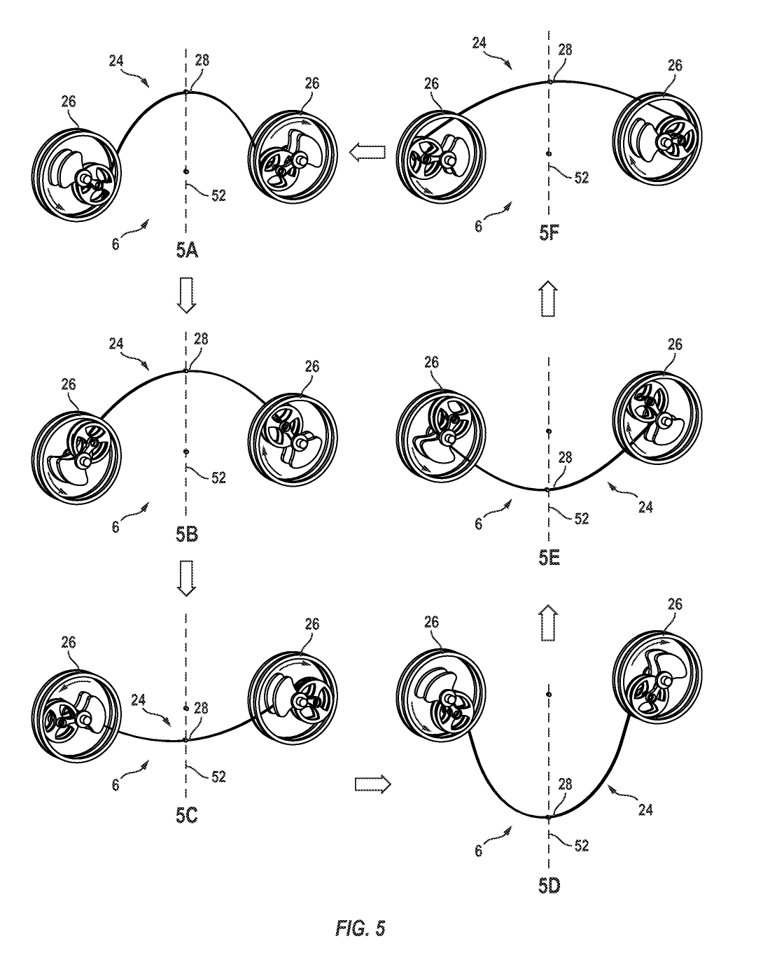

FIGS. 5A-5F depict snapshots of exemplary target launch apparatus 6 during operation, according to an embodiment of the present invention. Launch apparatus 6 can be implemented, e.g., as apparatus 6 of FIG. 3. Each frame in FIGS. 5A-5F depicts the beam's configuration at different points in a single vibration cycle of beam 24. As set forth above, drivers 26 drive both ends of beam 24 in concert so as to induce a steady and large amplitude vibration in beam 24. The vibration causes the beam to oscillate between two catenary-like configurations (FIG. 5A and FIG. 5F). A midpoint region 28 of beam 24 oscillates along a linear trajectory 52. In this particular embodiment, drivers 26 are hypocycloidal drivers with linear driving forces. The ends of beam 24 are coupled to a portion of the inner wheel of one of the hypocycloidal drivers. A motor of the hypocycloidal driver (not shown), drives the inner wheel along the outer rim to drive the ends of beam 24. In this particular embodiment, the beam ends are coupled to an outer edge of the inner wheel radius. The inner wheel on the left hypocycloidal driver travels along the outer rim in a counter clockwise fashion. The inner wheel on the right hypocycloidal driver travels along the outer rim in a clockwise fashion.

FIG. 5A depicts the beam configuration during a point in the loading period of the vibration cycle of beam 24. Thus, target 4 may be loaded at midpoint region 28 during the loading period shown in FIG. 5A. As illustrated in FIG. 5B, drivers 26 are driving the ends of beam 24 so as to accelerate midpoint region 28 in a downward trajectory from its loading position illustrated in FIG. 5A. FIG. 5C represents the beam configuration at the launch point in the vibration cycle. As set forth above, at the launch point, midpoint region 28 is at a peak velocity in the direction of the fusion chamber. In certain embodiments, the midpoint region acceleration is zero at the launch point. A loaded target 4 would be launched from the target launch apparatus 6 at the peak velocity of midpoint region 28 toward the fusion chamber 8 along midpoint trajectory 52. This particular embodiment avoids adding sliding friction heat to target 4 during launch. Moreover, a simple rotational input from a motor may drive launch apparatus 6. Thus gas and chemical requirements are reduced as well.

FIG. 5D represents the beam configuration at the midpoint of the vibration cycle of beam 24. At FIG. 5D, midpoint region 28 of beam 24 reaches a peak displacement in a downward direction and has a zero velocity. At FIGS. 5E and 5F of the vibration cycle, drivers 26 drive the ends of beam 24 so as to return beam 24 to the beam configuration in FIG. 5A where another target 4 may be loaded and launched with the following vibration cycle. In this particular embodiment, the inner wheels of the hypocycloidal drivers make two revolutions around the outer rim for each vibration cycle. Drivers 26 may continue driving the ends of beam 24 to maintain the vibration and oscillation of beam 24. This vibration and oscillation may continue for as long as necessary so as to provide a continual supply of targets 4 to fusion chamber 8. In exemplary embodiments, drivers 26 may be controlled and beam 24 may be configured to produce a beam vibration frequency of between 1-20 Hz. In certain embodiments, drivers 26 and beam 24 may be configured to produce a beam vibration frequency of between 8-16 Hz. Additionally, beam 24 and driver 26 may be configured to produce a peak midpoint velocity of between 100-250 m/s. In some embodiments, launch apparatus 6 may be configured to have a peak midpoint velocity of between 150-200 m/s. Although drivers 26 of this embodiment are hypocycloidal drivers, many other drivers may be used to produce the desired beam vibration.

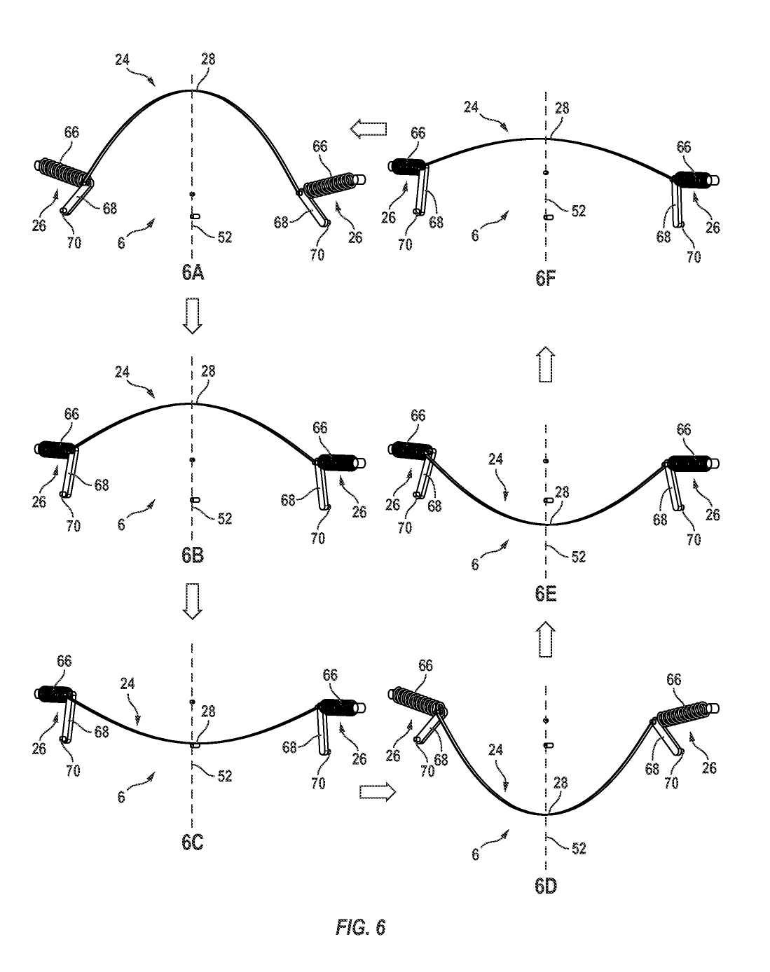

For example, FIGS. 6A-6F shows the operation of another exemplary embodiment of the present invention. In this embodiment, drivers 26 include a pivoting link 68 coupled to springs 66. Springs 66 may be configured to store and release potential energy when driving beam 24 to the desired vibration. The driver links 68 pivot around the pivot point 70. A motor (not shown) may be used to drive the driver links 68 to induce the desired vibration in attached beam 24. This embodiment may increase the efficiency of the overall system by converting kinetic energy to potential energy and then releasing the potential energy to assist in driving beam 24.

Starting at top left, FIG. 6A illustrates the beam configuration during a point in the loading period of the vibration cycle of beam 24. As can be seen, springs 66 are stretched during the loading period of target launcher 6. At FIGS. 6B and 6C, springs 66 contract, which assists in driving midpoint region 28 in a downward trajectory from its position in frame 54. Similar to the embodiment in FIG. 5A-5F, midpoint region 28 oscillates along midpoint trajectory 52. FIG. 6C is representative of the launch point. At this point, the velocity reaches a peak velocity and the target is launched from the midpoint region. In certain embodiments, midpoint region 28 acceleration is zero at the launch point. Further in some embodiments, springs 66 may no longer release stored potential energy at this point. FIG. 6D represents the apparatus configuration at the midpoint of the vibration cycle of beam 24. Springs 66 are once against out stretched. The stored potential energy of springs 66 in FIG. 6D is released to help return beam 24 (FIGS. 6E and 6F) to the beam configuration in FIG. 6A. As shown, drivers 26 may utilize springs 66 to store and release potential energy to help efficiently drive beam 24. In some embodiments, springs 66 may increase the efficiency of the overall apparatus operation. Although only one spring 66 configuration is shown, it should be understood that many configurations are possible and many drivers 26 may be used to provide the driving forces necessary to produce the larger amplitude vibration in beam 24. In some embodiments, a linear inductive motor may be coupled to link 68 to control beam 24 ends.

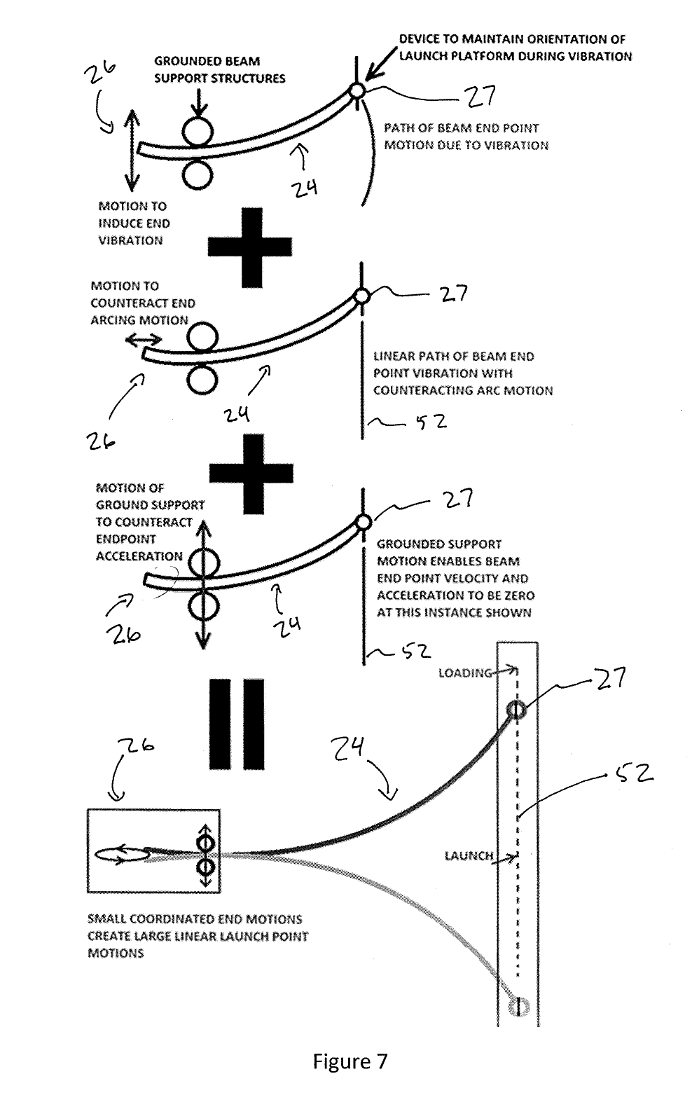

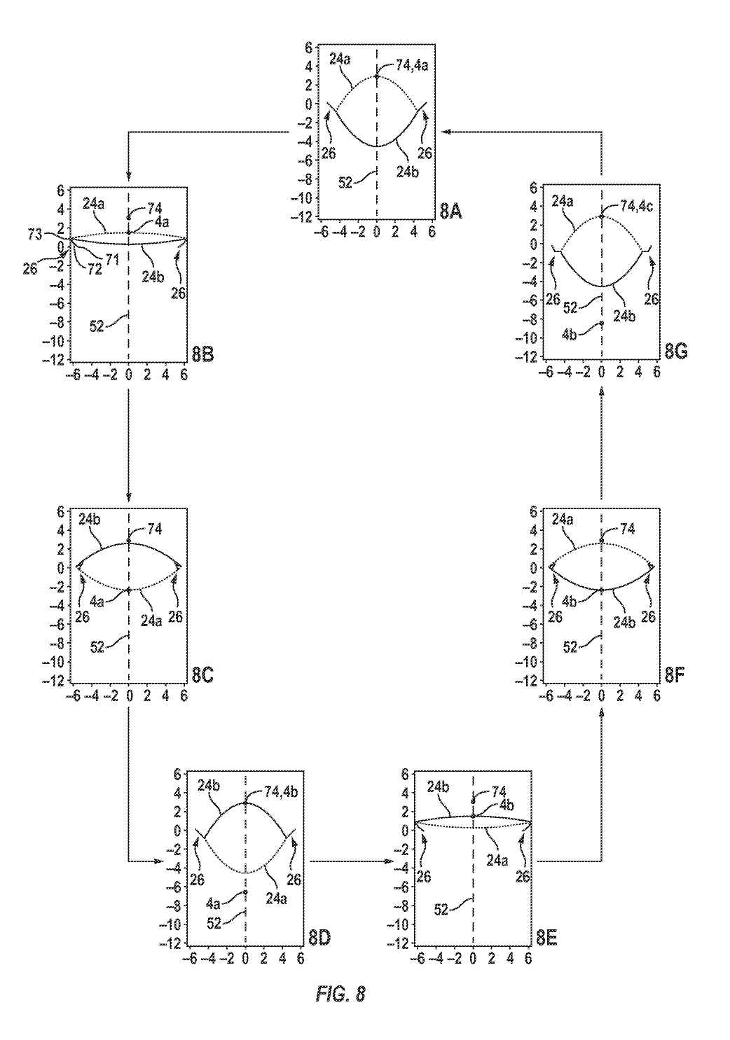

Alternatively, launch apparatus 6 may comprise driver 26 coupled to one end of beam 24 and beam 24 may have a cantilevered end 27 for launching a projectile as shown in FIG. 7. Driver 26 may be configured to drive the end of the beam 24 such that the cantilevered end 27 of the beam 24 vibrates along a linear path 52. Targets may then be placed at the cantilevered end 27 near the loading point and accelerated up to speed. The projectiles may then be launched at the launch point. Thus in certain embodiments, a single driver may be used to drive one end of the beam to launch projectiles. Further, some embodiments may utilize multiple beams as shown in FIG. 8.

FIG. 8 illustrates a simulation of a possible target launch apparatus 6 which utilizes two beams 24a and 24b. Both beams are coupled to simulated drivers 26. The drivers 26 in this embodiment operate similar to, e.g., the hypocycloidal drivers in FIG. 5. Link 71 is coupled to link 73 at joint 72. Link 73 is coupled to the ends of beam 24a and 24b. Link 73 rotates about joint 72 and link 71 rotates about its other end. The resulting driving input from drivers 26 is linear in this embodiment. As illustrated in FIG. 8, each beam 24a and 24b are driven inverse to one another so as to induce a large amplitude vibration in each beam. Target loader 74 provides targets 4 to the midpoint regions of beam 24a and 24b during each respective loading period. The vibration of beam 24a is opposite of the vibration of beam 24b. Thus twice as many targets may be launched in the same period in this embodiment compared to the target launch apparatus described in FIG. 5 when each apparatus is operated at the same frequency. Alternatively, the embodiment illustrated in FIG. 8 may operate at half of the frequency of the single beam embodiment in order to provide a similar launching rate. This reduced operational frequency may minimize wear on beams 24 which may increase the efficiency and longevity of such a system. In this embodiment beams 24a and 24b may be adjacent to one another or the drivers 26 may be configured to rotate the beams such that a beam which just launched a target may be repositioned during the vibration cycle so that the following beam may launch a target along the same trajectory.

Starting at FIG. 8A, it shows the loading period for beam 24a. Target loader 74 loads target 4a to the midpoint region of beam 24a. In contrast, beam 24b is at the peak displacement closest to the fusion chamber (not shown). In FIG. 8B, drivers 26 drive beam 24a downward and beam 24b upward. At FIG. 8C, beam 24a reaches the launch point and launches target 4a along midpoint line 52. At FIG. 8D, beam 24b reaches the loading point and target loader 74 loads target 4b to the midpoint region of beam 24b. Beam 24a reaches the maximum displacement towards the fusion chamber. Target 4a is traveling along the midpoint region trajectory 52 towards the fusion chamber. At FIGS. 8E and 8F, drivers 26 drive beam 24a upwards and beam 24b downwards. At FIG. 8G, beam 24b has passed the launch point and has launched target 4b towards the fusion chamber. Beam 24a has reached the loading point and target loader 74 loads target 4c to the midpoint region of beam 24a. After FIG. 8G, the cycle is repeated—target 4c will be launched from beam 24a and another target will be loaded onto beam 24b and so on.

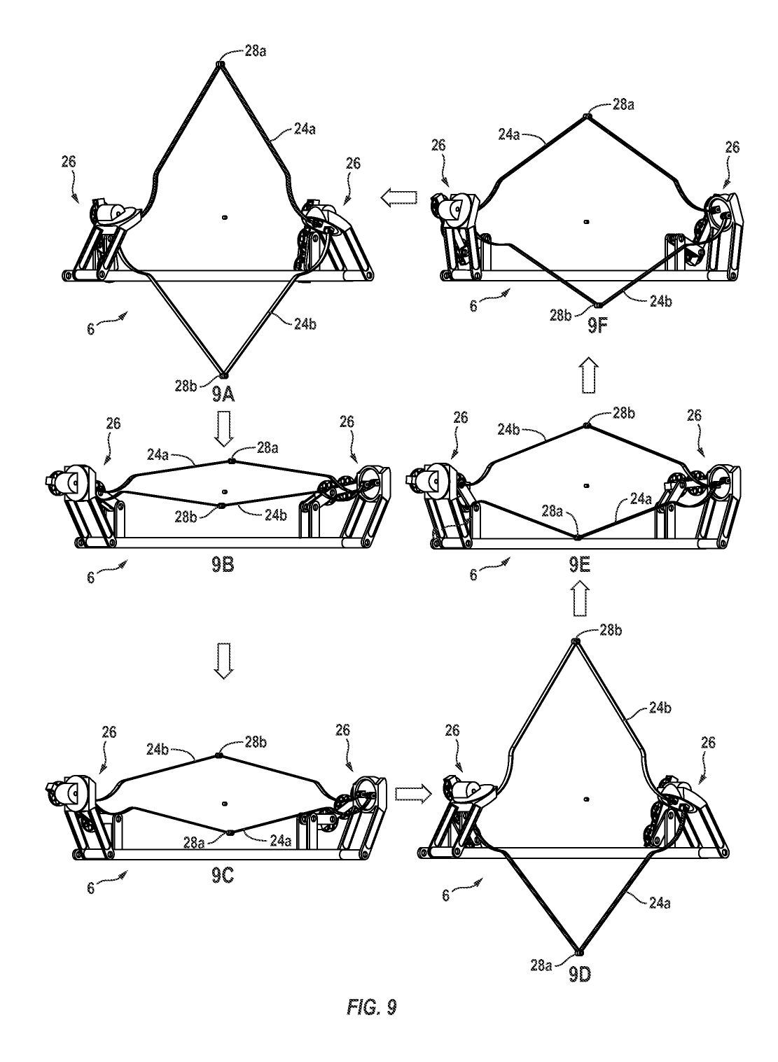

In further embodiments, beam 24 may comprise two or more rigid members that pivot at the midpoint as shown in FIG. 9. This particular embodiment utilizes two beams 24a and 24b, each comprising rigid members. Thus beam 24a and beam 24b may be an articulated assembly that vibrates back and forth. Further the drivers 26 in this embodiment comprise a two four-bar mechanism inputs, with gearing. Such an embodiment may be utilized to minimize the calculations required to generate a vibration of a flexible beam. At FIG. 9A, beam 24a is at a peak displacement from the fusion chamber (not shown) and a target may be loaded at midpoint region 28a. Further at FIG. 9A, beam 24b is at a peak displacement towards the fusion chamber. At FIG. 9B and 9C, drivers 26 drive beam 24a towards the launch point and beam 24b upwards to the loading point. At FIG. 9D, beam 24b reaches the loading point and a target may be loaded at midpoint region 28b of beam 24b. Beam 24a reaches a peak displacement towards the fusion chamber and has passed the launch point. A loaded target at midpoint region 28a would have been launched toward the fusion target by FIG. 9D. At FIG. 9E and 9F, drivers 26 drive beam 24a upwards toward the loading period and 24b downwards toward the launch point. Thereafter, the vibration cycle is repeated at FIG. 9A.

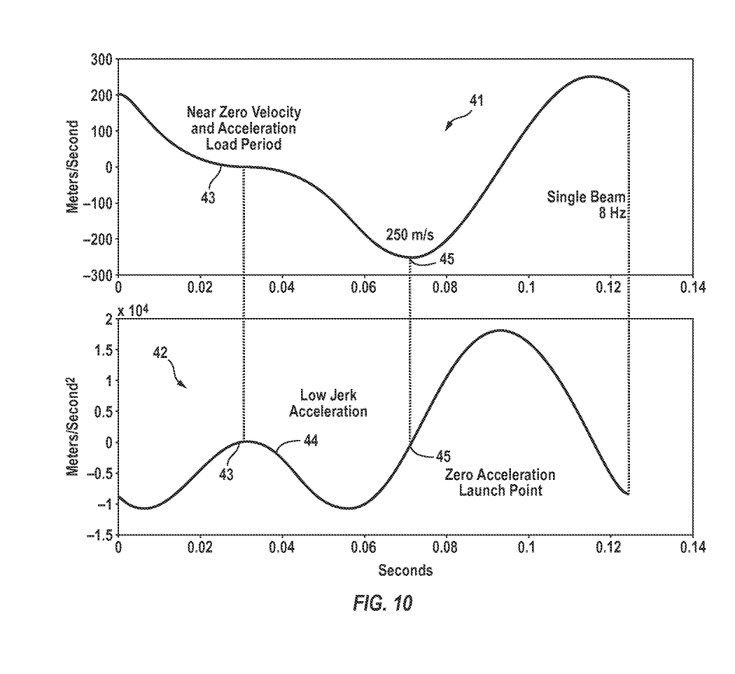

As described above, a beam can be driven in a manner to induce a steady and desired vibration in the beam. The beam has a midpoint that experiences the highest velocity and acceleration than any other point on the beam. FIG. 10 illustrates a velocity profile chart 41 and an acceleration profile chart 42 of the midpoint region of the beam during an exemplary vibration cycle, according to the embodiment of FIG. 5 and FIG. 8. Charts 41 and 42 illustrate a loading period 43 and launch points 44 of the beam vibration cycle. In this exemplary vibration cycle, the beam is vibrating at a frequency of about 8 Hz. Thus each vibration cycle of the beam vibration lasts about 0.125 seconds.

As shown in FIG. 10, the midpoint region of the beam has a near zero velocity and acceleration during loading period 43. The vertical line at loading period 43 represents the point in time where the midpoint region of the beam reaches a peak displacement from the downrange projectile target. Further, acceleration profile chart 42 shows how the beam provides a smooth and controlled acceleration 44 after loading period 43. This smooth and controlled acceleration 44 reduces unwanted jerk forces and shock loading on the target. At launch point 45, the velocity of the target reaches a peak velocity in the direction of the downrange projectile target. In certain embodiments, acceleration 42 reaches zero at the launch point. In this exemplary vibration configuration, the peak velocity is about 250 m/s. Thus a target launched from the midpoint region will have a launch velocity of about 250 m/s according to this exemplary vibration configuration. In subsequent cycles, additional projectiles may be loaded and launched thereafter.

The loading period may vary depending on the projectile and the apparatus configuration. In some embodiments, loading may occur at any point in time prior to the launching point. For example, if a single vibration cycle has 360° , the loading period may be peak displacement±15° in some embodiments. In certain embodiments, the loading point may be selected based on the potential for the loading mechanism to effectively load the target. In other embodiments, it may be preferable to have a loading period at peak displacement±10°. In further embodiments where the projectile may be sensitive to shock loading forces, the loading period may be peak displacement±2-5°. In some embodiments, the loading may be most simple when the launch point has a zero velocity and acceleration—which occurs at maximum displacement positions.

Discovery of beam endpoint motion that enables a launching apparatus to achieve proper beam vibration characteristics may utilize computational iteration. Finite element methods may be employed to fully optimize final solutions. Beam deflection shape during vibration can be geometrically approximated using the hyperbolic sine function associated with the catenary curve:

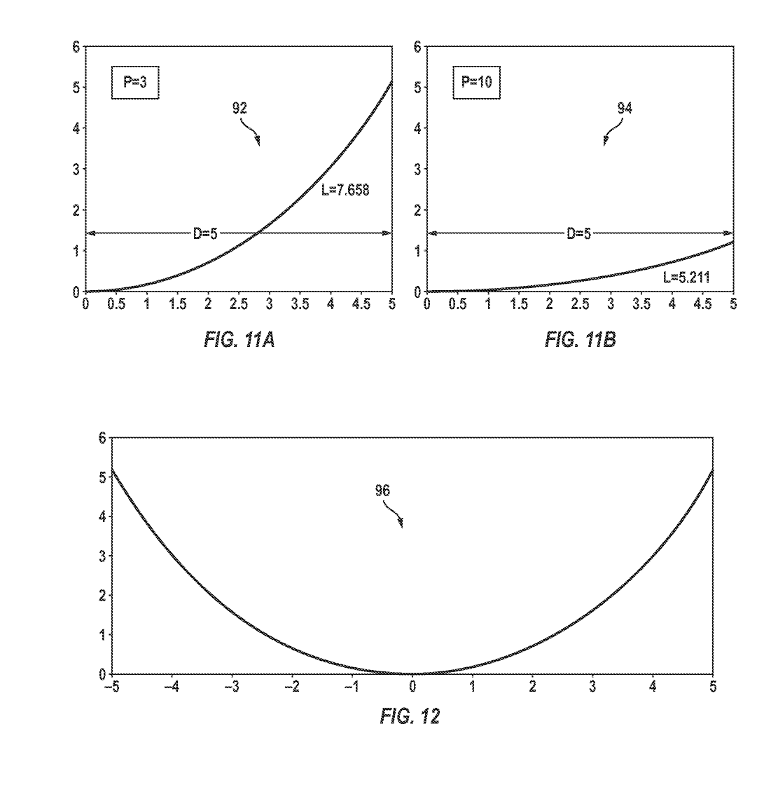

L=P*sin h(D/P) (1)

Where the variable L is equal to the arc length of the curve, variable P is a curvature factor, and D is the horizontal component. An exemplary development of deflected beam shape for a beam vibration launch apparatus is described herein, beginning with FIGS. 11A and 11B.

The value of P may be small, e.g. 3.0, when curvature 92 is significant as illustrated in FIG. 11A. The value of P is very large for curves 94 approaching a straight line as illustrated in FIG. 11B. During vibration of a beam with constant length L, the beam end position motions may be driven along the x-direction following simple harmonic motion and the horizontal dimension, D, varies. Using the above equation, the variable P may be solved. For each horizontal position of the end points, the full beam shape is now known and the y-direction position of points along the beam may be provided using a hyperbolic cosine catenary function. The solution may be adjusted such that position at x=0, y is also 0. Thus, by subtracting P in the last term we have:

y=P*cos h(x/P)−P (2)

As the beam vibrates, vertical y-direction motion of the endpoints is now known for the corresponding x-direction motion of the endpoints. FIG. 10 shows a deflected beam 96, at P=3, and having x-positions from −5 to 5 using the above equation.

The total length of beam 96 shown in FIG. 12 is calculated as:

2*L=2*P*sin h(D/P)=2*3*sin h(5/3)=2*7.658=15.316 (3)

Beam 96 is shown in the maximum downward defection during its vibration cycle and the motion in the x-direction at each end point oscillates between x=−7.658 and x=−5.000 on the left end and between x=7.658 and x=5.000 on the right end. The y-position of the endpoints shown is:

y=P*cos h(x/P)−P=3*cos h(5/3)−3=5.225 (4)

One can see that if the y-position of the endpoints is maintained at 5.225 and only x-direction motion exists, then the beam shown above, at the bottom of its vibration cycle, has a total vibration cycle with the midpoint of the beam oscillating vertically between a maximum y-position of y=2*5.225=10.45 and the minimum position of y=0.

Acceleration of the midpoint of the beam is greatest at the top and bottom of the vibration cycle. To create a moment in time such that a projectile can be loaded at the midpoint of the beam, it is convenient for the midpoint to be almost stationary. The y-positions of the endpoints are accelerated to directly counteract the acceleration of the midpoint at that loading time. Back-calculating from the known shape of the beam during the loading motion provides the final information for fully characterizing the endpoint motions for the launching apparatus. A variety of endpoint driving mechanisms can then be generated to force the prescribed motion at the endpoints.

This geometric solution is then optimized using finite element analysis (FEA) methods which can more accurately simulate the vibration motion of a beam. Effects of gravity, changes in beam cross-section and stiffness along its length, additional vibratory modes, etc. can be solved and accounted for using FEA and dynamic analyses.

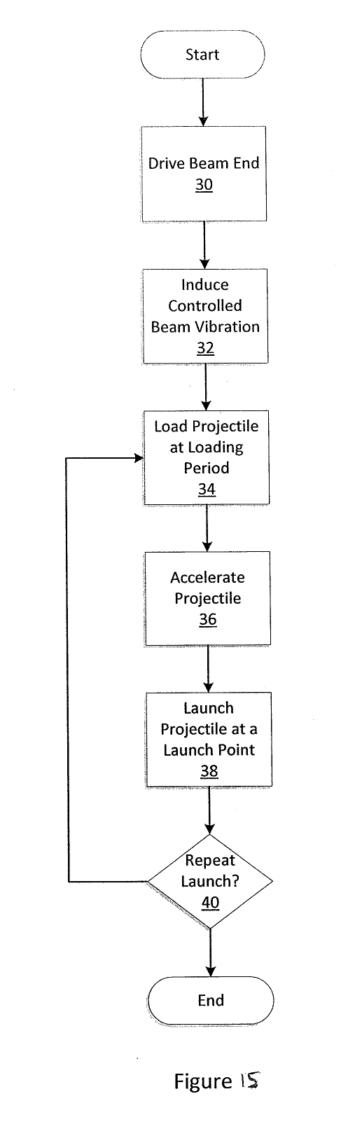

FIG. 13 shows an exemplary measured driving force 98 that may be needed to produce a desired vibration in the embodiment shown in FIG. 6. Line 100 in FIG. 13 generalizes the driving force necessary to drive beam ends to produce the exemplary beam vibration shown in FIG. 14. FIG. 14 illustrates an exemplary midpoint region's position 102, velocity 104, and acceleration 106 through multiple cycles of an exemplary vibration for the embodiment shown in FIG. 6. The loading period 108 and launch points 110 are indicated in each of the charts. In the exemplary vibration shown in FIG. 14, the beam vibrates at a frequency of 10 Hz. The midpoint region is displaced about 9 meters in every vibration cycle. The loading period is at about every 0.1 seconds and the launch velocity is about 180 m/s.

Although FIG. 14 illustrates the measurements of an exemplary vibration, it should be understood that the vibration may be configured to have varying specifications. The vibration frequency may range from about 0.5 Hz to about 20 Hz. Additionally the vibration may be configured to vary the launch velocity. In certain embodiments, the launch velocity may be about 100 m/s to about 250 m/s. Further, the acceleration profile may be constrained to define upper limits on acceleration. For example, some vibration configurations may be constrained to have a peak acceleration of about 7000 m/s² to about 9000 m/s². These constraints may be imposed depending on the type of projectile being launched.

FIG. 15 is a flow chart representing a method of launching a target according to embodiments of the present invention. According to FIG. 15, drivers cooperatively and continually drive beam ends 30 according to a particular driving input. The driving inputs at the ends of the beam induce a large amplitude vibration in the beam (step 32). As set forth above, the vibration causes the beam to oscillate between two catenary-like configurations with the midpoint of the beam forming the vertex of the curves throughout the vibration cycle. In some embodiments, the vibration frequency is between 1-20 Hz. Once the vibration frequency and amplitude stabilize, a target is loaded at the midpoint region of the beam during a loading period of the vibration cycle of the beam (step 34). As set forth above with regards to FIG. 10, the loading period of the vibration cycle is a period where the midpoint of the beam has a velocity and acceleration near zero. Additionally, the midpoint region displacement is near a peak displacement from the fusion chamber. At step 36, the target is accelerated toward the fusion chamber by the displacement of the beam. The target is launched from the target launcher at a launch point of the vibration cycle (step 38). The launch point of the vibration cycle is a point after the loading period where the midpoint velocity reaches a peak velocity towards the fusion chamber. After target launch 38, additional targets may be launched 40 because of the beam's continued oscillation. At the next loading period after target launch, additional targets may be loaded 34, accelerated 36, and launched 38. This may be repeated as many times as needed so as to provide a continual supply of targets 4 to fusion chamber 8.

Although the method described above discusses launching projectiles in a downward trajectory. It should be understood that the apparatus may be utilized to launch targets in other directions. For example, the apparatus may be located under a fusion chamber and may be configured to launch targets upwards into the fusion chamber. In other embodiments, the apparatus may be used to launch other projectiles and may be configured to launch the projectiles in various directions as needed. Further the targets may be loaded in various manners. For example, the targets may be loaded by an apparatus which precisely time and position the target at the midpoint region during the loading period. Additional loading methods may comprise delivering the target with a relatively small velocity along the same trajectory as the midpoint region such that the midpoint region engages the target during or shortly after the loading period. The midpoint region would thereafter accelerate the target until the midpoint region reaches the launching point.

While the invention is susceptible to various modifications and alternative constructions, certain illustrated embodiments thereof are shown in the drawings and described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The terms “comprising,” “having,” “including,” and “containing” are to be construed as open-ended terms (i.e., meaning “including, but not limited to”) unless otherwise noted. The term connected is to be construed as partly or wholly contained within, attached to, or joined together, even if there is something intervening Recitation of ranges of values herein are merely intended to serve as a shorthand method of referring individually to each separate value falling within the range, unless otherwise indicated herein, and each separate value is incorporated into the specification as if it were individual recited herein. All methods described herein can be performed in any suitable order unless otherwise indicated or clearly contradicted by context. The use of any and all examples or exemplary language is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated or otherwise clearly contradicted by context.

What is claimed is:

1. A method of accelerating a projectile, the method comprising:
driving at least one end of a beam in a repeated motion to induce a steady vibration in the beam, the beam having a launching region which oscillates along a linear path;
launching a projectile from the launching region along a linear trajectory at a launching point of a beam vibration cycle, the launching point comprising a point when the launching region is at a peak velocity.

2. The method of claim 1, further comprising:
loading the projectile at the launching region of the beam during a loading period of the beam vibration cycle; and
accelerating the projectile along the linear trajectory with the beam vibration.

3. The method of claim 2, wherein the loading period is characterized by a launching region peak displacement point in the beam vibration cycle plus or minus 10 degrees of the vibration cycle.

4. The method of claim 1, wherein the vibration of the beam causes the beam to oscillate between two catenary-like configurations with a midpoint region of the beam forming a vertex of the configurations.

5. The method of claim 1, wherein the beam comprises at least two rigid members, and wherein the rigid members are connected in series so as to create a structure of connected rigid members.

6. The method of claim 1, further comprising concurrently driving a second end of the beam to induce the vibration and wherein the launching region of the beam comprises the midpoint region of the beam.

7. The method of claim 6, wherein the beam is flexible.

8. The method of claim 7, wherein the flexible beam is between 6 meters and 12 meters long.

9. The method of claim 6, wherein the beam comprises at least two rigid members, and wherein the rigid members are connected in series so as to create a structure of connected rigid members.

10. The method of claim 6, wherein the driving comprises operating a pair of hypocycloidal drivers in parallel, and wherein one hypocycloidal driver is coupled to each end of the beam.

11. The method of claim 6, wherein the driving comprises operating a pair of parallel drivers which store and release potential energy in the flexed beam through the use of one or more springs.

12. The method of claim 1, wherein the beam comprises carbon fiber material.

13. The method of claim 1, wherein a velocity of the projectile is between 150 m/s and 250 m/s when it is released from the launching region.

14. The method of claim 1, wherein the midpoint region has a peak acceleration in the range of about 7,500 m/s² to about 8,500 m/s².

15. The method of claim 1, wherein a beam vibration frequency is between 8 Hz and 16 Hz.

16. A mechanical launch apparatus for launching targets into a fusion reaction chamber, the mechanical launch apparatus comprising:
a flexible beam having a midpoint region and two ends;
at least two drivers, each driver coupled to one of the two ends of the beam, the drivers configured to drive both ends of the beam so as to induce a steady vibration in the beam, the vibration of the beam causing the beam to oscillate between two deflected shape configurations where the midpoint region of the beam forms a vertex of the deflected shape configurations.

17. The mechanical launch apparatus of claim 16, wherein the deflected shape configurations comprise catenary-like configurations.

18. The mechanical launch apparatus of claim 16, wherein the beam comprises carbon fiber material.

19. The mechanical launch apparatus of claim 17, wherein each end of the beam has a first width that is greater than a second width at the midpoint region so as to increase a torsional rigidity of the beam.

20. The mechanical launch apparatus of claim 16, wherein the at least two drivers comprise hypocycloidal drivers.

21. The mechanical launch apparatus of claim 16, wherein the at least two drivers comprise a driver configured to store and release potential energy from the beam vibration through the use of one or more springs.

22. The mechanical launch apparatus of claim 16, wherein a cross section of the beam varies along a length of the beam.

23. A method of accelerating a projectile, the method comprising:
driving two ends of a member in a repeated motion, the member having a midpoint region that oscillates along a linear path;
inducing a steady vibration in the member such that the beam oscillates between two deflected shape configurations with the midpoint region forming the vertex of the deflected shape configurations throughout each vibration cycle; and
launching a projectile from the midpoint region of the member at a launching point of the vibration cycle, the launching point comprising a point where the midpoint region is at a peak velocity.

24. The method of claim 23, wherein the beam comprises a carbon fiber material.

25. The method of claim 23, wherein the deflected shape configurations comprise catenary-like configurations.
